(19) United States
(12) Patent Application Publication
(10) Pub. No.: US 2021/0139094 A1
(43) Pub. Date: May 13, 2021

(54) INFORMATION PROCESSING APPARATUS, INFORMATION PROCESSING METHOD AND STORING MEDIUM

(71) Applicant: Toyota Jidosha Kabushiki Kaisha, Toyota-shi (JP)

(72) Inventors: Shintaro Matsutani, Kariya-shi (JP); Aya Sato, Miyoshi-shi (JP); Yasuki Nakagawa, Toyota-shi (JP); Shigeru Inamori, Nagoya-shi (JP); Fuminori Matsuoka, Toyota-shi (JP); Taro Hasegawa, Toyota-shi (JP); Masaki Nanahara, Toyota-shi (JP); Misaki Sato, Nisshin-shi (JP); Motoki Maekawa, Nagakute-shi (JP); Hiroki Ashizawa, Toyota-shi (JP)

(21) Appl. No.: 17/095,233

(22) Filed: Nov. 11, 2020

(30) Foreign Application Priority Data
Nov. 13, 2019 (JP) 2019-205544

(51) Int. Cl. B62D 65/04; B60P 3/42; B60P 3/20; B60P 3/025; G05B 19/4155

(52) U.S. Cl. CPC B62D 65/04; B60P 3/426; G05B 2219/31029; B60P 3/0257; G05B 19/4155; B60P 3/20

(57) ABSTRACT

An information processing apparatus comprises a controller configured to determine a combination of two or more units having different functions to be loaded on a vehicle platform, and generate a command to assemble a vehicle used for a predetermined application from the determined units.

### CROSS REFERENCE TO RELATED APPLICATION

This application claims priority to Japanese Patent Application No. 2019-205544, filed on Nov. 13, 2019, incorporated herein by reference in its entirety.

### BACKGROUND

### Technical Field

The present disclosure relates to a technique of providing a service by vehicle.

### Description of the Related Art

Attempts have been made to provide services by sending automobiles designed for various purposes. For example, Patent document 1 discloses an apparatus that determines a vehicle to be sent based on the demand for a service and the availability of vehicles and indicates the vehicle to move.

The vehicle is formed by a combination of a vehicle platform (chassis) and a cabin module (cabin), and the cabin can be changed to meet various demands.

### CITATION LIST

Patent document 1: Japanese Patent Laid-Open No. 2019-075047

### SUMMARY

According to the invention described in Patent document 1, by changing the cabin loaded on the chassis, the use of the vehicle can be changed. However, the equipment change can be performed only on a cabin basis, so that part of the equipment may be wasted.

The present disclosure has been devised in view of the problem described above, and an object of the present disclosure is to provide a vehicle that can be flexibly used for various applications.

A first aspect of the present disclosure is an information processing apparatus that generates a command to assemble a vehicle.

Specifically, the information processing apparatus includes a controller configured to determine a combination of two or more units having different functions to be loaded on a vehicle platform, and generate a command to assemble a vehicle used for a predetermined application from the determined units.

A second aspect of the present disclosure is an information processing method performed by the information processing apparatus.

Specifically, the information processing method includes a step of determining a combination of two or more units having different functions to be loaded on a vehicle platform, and a step of generating a command to assemble a vehicle used for a predetermined application from the determined units.

Another aspect may be a program that makes a computer perform the information processing method performed by the information processing apparatus or a computer readable memory medium non-temporarily storing the program.

Another aspect may be a vehicle system that assembles the vehicle by loading the two or more units specified by the information processing apparatus described above on the vehicle platform.

Another aspect may be a vehicle that includes the vehicle platform and the two or more units specified by the information processing apparatus described above that are loaded on the vehicle platform and serves a predetermined function determined by the combination.

According to the present disclosure, a vehicle that can be flexibly used for various applications can be provided.

### BRIEF DESCRIPTION OF THE DRAWINGS

FIG. 1 is a diagram illustrating a general configuration of a vehicle system according to a first embodiment.

FIG. 2 is a view illustrating an appearance of a vehicle according to the first embodiment.

FIG. 3A is a diagram illustrating a combination of body units for one application.

FIG. 3B is a diagram illustrating a combination of body units for another application.

FIG. 3C is a diagram illustrating a combination of body units for another application.

FIG. 3D is a diagram illustrating a combination of body units for another application.

FIG. 3E is a diagram illustrating a combination of body units for another application.

FIG. 3F is a diagram illustrating a combination of body units for another application.

FIG. 4 is a diagram illustrating a system configuration of a center server.

FIG. 5 illustrates an example of assembly data stored in the center server.

FIG. 6A illustrates an example of chassis information stored in the center server.

FIG. 6B illustrates an example of body information stored in the center server.

FIG. 7 is a diagram illustrating a system configuration of a vehicle assembly server.

FIG. 8 is a diagram illustrating a system configuration of a chassis unit.

FIG. 9 is a diagram illustrating a process in which the center server updates a vehicle database in detail.

FIG. 10 is a diagram illustrating a process of assembling a vehicle in detail.

### DESCRIPTION OF THE EMBODIMENTS

An information processing apparatus according to an embodiment determines a combination of two or more units having different functions to be loaded on a vehicle platform, and generates a command to assemble a vehicle used for a predetermined application from the determined units.

The vehicle platform is a mobile body provided with a plurality of wheels and a power source. The vehicle platform has only to be able to travel and does not have to have a cabin. The vehicle platform is configured so that a plurality of units having different functions can be loaded thereon. By loading a predetermined unit on the vehicle platform, a vehicle used for a predetermined application can be assembled. By replacing a loaded unit with another unit, the application of the vehicle can be changed. The information processing apparatus according to the embodiment is an apparatus that generates a command to assembly such a vehicle.

In this specification, the vehicle platform will be referred to as a chassis unit, and the unit loaded on the chassis unit will be referred to as a body unit.

Units that can be loaded on the vehicle platform include a unit providing a cabin space, a unit on which a package is loaded, a unit having cooking equipment, a unit providing a refrigeration/freezing function, a unit providing plumbing equipment, and a unit providing a power supply, for example. However, other units are also possible.

In the embodiment, two or more units having predetermined functions are selected, and the combination of units is loaded on the vehicle platform, rather than loading a single cabin on the vehicle platform. Therefore, the assembled vehicle can serve a predetermined function (for example, the vehicle serves as a restaurant if a seating unit and a cooking unit are combined).

The information processing apparatus may further include a storage unit configured to store the combination of two or more units in association with the application of the vehicle.

Furthermore, information that specifies the application of the vehicle may be obtained from a user, and the combination of units suitable for the application may be determined based on the stored data.

With such a configuration, when a vehicle used for a predetermined application is requested, appropriate units to be loaded on the vehicle platform can be selected.

The application of the vehicle may be transportation of freight, and the two or more units may include at least a housing unit that independently functions as a parcel locker (Locker for receiving deliveries, installed to in designated locations. Also called a delivery Locker).

A unit itself may have a function as a parcel locker. That is, a unit used for containing and conveying a package may serve as a parcel locker after the unit is separated from the vehicle. With such a configuration, both the conveyance of the package and the unattended pickup of the package can be provided. Furthermore, by changing the number of the units loaded, the number of sites where parcel lockers are placed can be changed.

The two or more units may include at least a constant-temperature transportation unit.

The constant-temperature transportation unit is a unit used for transporting a package by keeping the temperature of the package constant. The constant-temperature transportation unit does not always have to be provided with a heat source, a cooling device or the like. Combining the constant-temperature transportation unit with a heat source or a cooling device allows constant-temperature transportation, refrigerated transportation, frozen transportation or the like by vehicle.

The information that specifies the application of the vehicle may include information that indicates a quantity of freight to be transported, and the number of units to be combined may be determined based on the quantity of freight.

By appropriately determining the number of units based on the quantity of the freight to be loaded, any remaining space can be efficiently used.

The application of the vehicle may be provision of food and drink, and the two or more units may include at least any of a cooking unit and a water supply and drain unit.

Combining the cooking unit and the water supply and drain unit allows cooking of food and drink.

The generated command may be transmitted to a base capable of providing the determined two or more units among a plurality of bases where a vehicle is assembled.

Information concerning a unit that can be provided can be periodically collected from the plurality of bases.

In the following, embodiments of the present disclosure will be described. The configurations of the embodiments described below are given for illustrative purposes, and the present disclosure is not limited to the configurations of the embodiments.

### First Embodiment

FIG. 1 is a diagram illustrating a configuration of a vehicle system according to a first embodiment. The vehicle system according to this embodiment includes a center server 100, one or more vehicle assembly servers 200, and one or more vehicles 300.

In this embodiment, the vehicle 300 is a vehicle with a chassis part and a body part that can be separated from each other. In the following, the chassis part will be referred to as a chassis unit 310, and the body part will be referred to as a body unit 320. The chassis unit 310 is configured so that a plurality of body units 320 having different functions can be loaded thereon. In the following, the term “body unit 320” will be used to generically refer to a plurality of body units having different functions.

The body unit 320 of the vehicle 300 can be changed at a vehicle assembly base. The vehicle assembly base is a base where the chassis unit 310 and the body unit 320 are coupled to each other or separated from each other. At the vehicle assembly base, chassis units 310 and body units 320 can be stored when the units are out of service.

The vehicle assembly server 200 is a server apparatus that controls an apparatus or system that assembles the vehicle 300. Assembling a vehicle means loading one or more body units 320 on a particular chassis unit 310 to form a vehicle 300 used for a predetermined application. The vehicle can be assembled by conveying and loading a plurality of body units 320 prepared in advance on an intended chassis unit 310. The vehicle assembly server 200 is installed at each vehicle assembly base.

The center server 100 is an apparatus that performs a control to send a vehicle 300 in response to a dispatch request from a user. The user may be a consumer who uses the vehicle 300 or an enterprise or the like that manages the operation of the vehicle 300.

Specifically, the center server 100 stores the type of the body unit 320 to be loaded on the chassis unit 310 on a vehicle application basis, and determines which type of vehicle 300 is needed by the user and then determines the combination of the chassis unit 310 and the body unit 320.

The center server 100 then identifies a vehicle assembly base that can provide the determined type of body unit 320, and transmits a command to combine the chassis unit 310 and the body unit 320 to the vehicle assembly server 200 at the base.

The center server 100, the one or more vehicle assembly servers 200 and the one or more vehicles 300 (one or more chassis units 310) are interconnected over a network. The network may be a wide area network (WAN) that is a global public communication network, such as the Internet, or other communication networks. The network may include a telephone network for cellular phones or the like or a wireless communication network, such as Wi-Fi (registered trademark).

Next, the assembly of the vehicle 300 will be described in more detail.

FIG. 2 is a view showing an appearance of the vehicle 300. The vehicle 300 according to this embodiment includes a chassis unit 310 and a body unit 320.

The chassis unit 310 is an autonomous driving car that autonomously travels. The chassis unit 310 includes a wheel, a prime mover or electric motor, an apparatus that controls the traveling, and an automatic driving apparatus, for example, and travels according to a command transmitted from an apparatus that manages the operation of the vehicle 300. The chassis unit 310 can move with one or more body units 320 coupled thereto but can travel alone. The chassis unit 310 has a capability of communicating with the center server 100. This capability allows the chassis unit 310 to transmit information on the current position or operational state of the chassis unit 310 to the center server 100.

Although the chassis unit 310 is an autonomous traveling vehicle in this embodiment, the chassis unit 310 may be a vehicle operated by a driver or a semi-autonomous traveling vehicle that travels under the supervision of a driver.

The body unit 320 is a unit loaded on the chassis unit 310 for use. In this embodiment, a plurality of units having predetermined functions is illustrated as the body unit 320. For example, the body unit 320 may be a unit used as a cabin (or an office room, a bed room or the like), a unit used as a sales space in a retail business, a unit used as seating room (or a cooking room) in a restaurant business, or a freight transportation unit in a physical distribution business. However, the body unit 320 can also be other units. The body unit 320 can not only bear people or freight but also can provide a resource. For example, the body unit 320 may be a unit that supplies electricity, a refrigerator or freezer unit, a water supply or drain unit, or a sewage treatment unit. A vehicle 300 used for a predetermined application can be assembled by loading a plurality of body units 320 in combination on the chassis unit 310.

Although the body unit 320 has been described as being loaded on the chassis unit 310 in the above example, the body unit 320 does not always have to be loaded on the chassis unit 310 as far as the chassis unit 310 and the body unit 320 can be coupled to each other in a predetermined manner.

The method of coupling the chassis unit 310 and the body unit 320 to each other is not limited to any particular method. For example, the chassis unit 310 and the body unit 320 may be mechanically coupled and separated with a lock mechanism or may be coupled and separated with an electromagnet or the like.

The method of loading the body unit 320 on the chassis unit 310 or unloading the body unit 320 from the chassis unit 310 may be a method of using a dedicated elevator or a method of using an accessory mechanism of the chassis unit 310 or body unit 320, for example. With the vehicle 300, the method of loading the body unit 320 on the chassis unit 310 or unloading the body unit 320 from the chassis unit 310 is not limited

Next, ways of selecting body units to form vehicles 300 used for predetermined applications will be described.

FIGS. 3A to 3C illustrate examples in which the vehicle 300 serves as a shop.

A show room unit illustrated in FIG. 3A is a unit used mainly for exhibition of commodities. A register unit is a unit that includes a cash register, a payment terminal, a safe and the like and is used mainly for payment. A vehicle 300 with these units in combination can serve as a mobile shop for selling commodities.

A refrigerated sales unit illustrated in FIG. 3B is a unit having a refrigerated show case. A room-temperature sales unit is a unit having a room-temperature show case. A vehicle 300 with these units in combination can serve as a mobile shop for selling foods or daily necessities.

A seating unit illustrated in FIG. 3C is a unit that includes a table and a chair and is used by a consumer who is provided with a service. A cooking unit is a unit that includes a cooking heater, a sink, a refrigerator and the like and is used for cooking of foods. A power supply unit is a unit that provides electricity for service to the cooking heater or refrigerator. A water supply unit is a unit that provides water for cooking. A vehicle 300 with these units in combination can serve as a mobile restaurant.

FIGS. 3D to 3F illustrate examples in which the vehicle 300 serves as a delivery vehicle.

A parcel locker unit illustrated in FIG. 3D is a unit that has a plurality of compartments that can be independently locked and can contain a package in each compartment. One or more parcel locker units can be loaded on the chassis unit 310 of the vehicle 300, and the parcel locker units can be unloaded at the destination. That is, a parcel locker unit in which a package is put in advance can be installed at any location (such as in the premises of a station or public facility) by unloading the parcel locker unit after autonomous movement.

A transportation unit illustrated in FIG. 3E is a unit for containing a plurality of packages and transporting the packages at room temperature. By downsizing each unit, the number of the units to be loaded can be flexibly increased or decreased depending on the number of the packages to be loaded. That is, when the vehicle 300 is used as a delivery vehicle, space can be efficiently used.

FIG. 3F illustrates an example in which room-temperature transportation and constant-temperature transportation are performed at the same time. In this example, in addition to a unit for room-temperature transportation, a unit capable of heat-insulated transportation, a unit for cooling, and a unit for supplying electricity are loaded. With such a configuration, both the refrigerated (frozen) transportation and the room-temperature transportation can be performed.

Although FIG. 3 illustrate examples in which the vehicle 300 serves as a shop and examples in which the vehicle 300 serves as a delivery vehicle, the vehicle 300 can be assembled by other combinations than those illustrated as far as the vehicle 300 includes a combination of a plurality of body units and can be used for a predetermined application.

For example, a rest space, a dining space (such as an eating space), a space for makeup or grooming, a space for business (such as a meeting room), or a space for entertainment can also be provided.

Next, the center server 100 will be described in detail.

FIG. 4 is a diagram illustrating a system configuration of the center server 100. The center server 100 includes a communication part 101, a memory part 102 and a control part 103.

The center server 100 is constituted by a common computer. Specifically, the center server 100 is a computer having a processor, such as a CPU or GPU, a main memory, such as a RAM or a ROM, and an auxiliary memory, such as an EPROM, a hard disk drive or a removable medium. The removable medium may be an USB memory or a disk recording medium, such as a CD or a DVD. The auxiliary memory stores an operating system (OS), various programs, or various tables, and each of the various functions described later suitable for a predetermined purpose can be implemented by loading a program stored in the auxiliary memory into a working area of the main memory and executing the program to control each component or the like. However, some or all of the functions may be implemented by a hardware circuit, such as ASIC or FPGA. The center server 100 may be constituted by a single computer or a plurality of computers associated with each other.

The communication part 101 is a communication interface unit that connects the center server 100 to the network. The communication part 101 includes a network interface board and a wireless communication circuit for wireless communication.

The memory part 102 (storage unit) includes the main memory and the auxiliary memory. The main memory is a memory in which a program to be executed by the control part 103 or data to be used by the control program is deployed. The auxiliary memory is a memory that stores a program to be executed by the control part 103 or data to be used by the control program.

The memory part 102 further stores assembly database 102A and a vehicle database 102B.

The assembly database 102A is a database that stores information (assembly data) concerning a combination of units that form a vehicle 300 used for a predetermined application.

FIG. 5 illustrates an example of the assembly data. The data is data that describes applications of vehicles 300 and what units with what functions need to be combined in order to form a vehicle 300 used for a particular application (that is, the number and types of units).

The vehicle database 102B is a database that stores operational information on the vehicle 300. The vehicle database contains a table in which information concerning a chassis unit (chassis information) such as that illustrated in FIG. 6(A) is recorded and a table in which information concerning a body unit (body information) such as that illustrated in FIG. 6(B) is recorded.

The chassis information includes the positional information on the relevant chassis unit 310, the operational state of the relevant chassis unit 310 (such as whether the chassis unit is on standby, is assembled and in operation, or is out of service), or information that identifies the body unit(s) 320 loaded.

The body information includes an attribute of the relevant body unit 320 (a function provided), the positional information on the relevant body unit 320, the operational state of the relevant body unit 320 (such as whether the body unit is separated or is assembled and in operation), or information that identifies the chassis unit 310 paired with the relevant body unit 320.

The chassis information is periodically updated based on information transmitted from the chassis unit 310. When the chassis unit 310 is not in operation, the chassis information is updated based on information transmitted from the vehicle assembly server 200.

The body unit 320 has no communication unit, so that the body information is updated based on the information transmitted from the vehicle assembly server 200.

These databases are constructed by a database management system (DBMS) executed by a processor managing the data stored in the memory. The databases used in this embodiment are a relational database, for example.

A way of using the data stored in the databases will be described later.

The control part 103 is a computing device (controller) that is responsible for the control performed by the center server 100. The control part 103 can be implemented by an arithmetic processing unit, such as a CPU.

The control part 103 has three functional modules, specifically, a vehicle management part 1031, a vehicle determination part 1032 and an assembly command part 1033. Each of the functional modules may also be implemented by the CPU executing a program stored in the auxiliary memory.

The vehicle management part 1031 collects the positional information and the operational information concerning the chassis unit 310 and the body unit(s) 320. Specifically, the vehicle management part 1031 periodically communicates with a plurality of chassis units 310 to collect information concerning the chassis units 310. The vehicle management part 1031 also collects information concerning the body unit(s) 320 loaded on the chassis unit 310. When the chassis unit 310 and the body unit(s) 320 are separated and standing still, the information concerning each unit is collected via the vehicle assembly server 200.

The collected information is reflected in the vehicle database 102B.

In response to a dispatch request for a vehicle 300 from a user, the vehicle determination part 1032 determines the combination of the chassis unit 310 and the body unit(s) 320 that form the desired vehicle for the user and the base where the vehicle is assembled.

The assembly command part 1033 generates a command to assemble a vehicle 300 by the combination determined by the vehicle determination part 1032 and transmits the command to the relevant vehicle assembly server 200. If the intended chassis unit 310 is traveling, the assembly command part 1033 can transmit a command to move to the determined vehicle assembly base to the chassis unit 310.

Next, a configuration of the vehicle assembly server 200 will be described.

FIG. 7 is a diagram illustrating a system configuration of the vehicle assembly server 200. The vehicle assembly server 200 includes a communication part 201, a memory part 202 and a control part 203.

As with the center server 100, the vehicle assembly server 200 is constituted by a common computer. The vehicle assembly server 200 may be constituted by a single computer or a plurality of computers associated with each other.

The communication part 201 is a communication interface that connects the vehicle assembly server 200 to the network. The communication part 201 includes a network interface board and a wireless communication circuit for wireless communication.

The memory part 202 includes a main memory and an auxiliary memory. The main memory is a memory in which a program to be executed by the control part 203 or data to be used by the control program is deployed. The auxiliary memory is a memory that stores a program to be executed by the control part 203 or data to be used by the control program.

The control part 203 is a computing device that is responsible for the control performed by the vehicle assembly server 200. The control part 203 can be implemented by an arithmetic processing unit, such as a CPU.

The control part 203 has two functional modules, specifically, a management part 2031 and an assembly part 2032. Each of the functional modules may also be implemented by the CPU executing a program stored in the auxiliary memory.

The management part 2031 manages the chassis unit 310 and the body unit(s) 320 at the vehicle assembly base where the vehicle assembly server 200 is installed. Specifically, when the chassis unit 310 and the body unit(s) 320 starts or ends the operation, the management part 2031 generates data that indicates where each unit is (whether each unit is at a particular vehicle assembly base or is traveling on a particular chassis unit) and notifies the center server 100. In this way, even when the vehicle is not in operation, the center server 100 can grasp the location of the chassis unit and the body unit(s).

The assembly part 2032 assembles a vehicle 300 based on a command from the center server 100. The assembly of the vehicle can be performed with a well-known unit, such as an elevator or a jack.

Next, the chassis unit 310 forming the vehicle 300 will be described.

FIG. 8 is a diagram illustrating an example of a hardware configuration of the chassis unit 310. In this embodiment, the chassis unit 310 is an electric vehicle capable of autonomous traveling.

The chassis unit 310 includes a control part 301, a communication part 302, a camera 303, a sensor 304, a motor part 305, an encoder part 306 and a global positioning system (GPS) receiver 307.

The control part 301 is a unit that controls the traveling of the vehicle. The control part 301 may be a general-purpose computer or an electronic control unit (ECU). When the control part 301 is a computer, the control part 301 may include a central processing unit (CPU) and a memory. The control part 301 may serve its function by the CPU executing a program stored in the memory.

The control part 301 controls the traveling of the vehicle by determining the velocity, trajectory or the like of the vehicle and driving the motor part described later based on information obtained from the camera and sensor described later and stored map data. Furthermore, the control part 301 determines the current location and the direction in which the vehicle to travel by checking a signal from the GPS receiver 307 against the previously stored map data. Furthermore, the control part 301 recognizes an obstacle around the vehicle 300 and controls the travel direction and steering angle to avoid the obstacle by processing an image obtained by the camera 303 with a predetermined frame period and a signal from a plurality of sensors 304.

In addition to controlling the traveling of the vehicle, the control part 301 may perform a control concerning the provision of a service. For example, the control part 301 may perform a control to set up a shop and start a business after arriving at a predetermined location.

The communication part 302 is a communication interface that communicates with various servers on the network. The communication part 302 establishes a wireless communication by using a radio signal and a radio communication method according to a predetermined radio communication standard. The data transmitted and received may be the data illustrated in this specification or may be other data, such as data concerning the automatic driving or data concerning the service provided to the user.

The camera 303 is a picture-taking device using an image sensor, such as a charged-coupled devices (CCD) image sensor, a metal-oxide-semiconductor (MOS) image sensor or a complementary metal-oxide-semiconductor (CMOS) image sensor. The camera 303 obtains images at predetermined time intervals referred to as a frame period, and stored the images in a frame buffer in the control part 301. A plurality of cameras 303 may be provided. For example, a camera 303 directed to the outside of the vehicle may be provided on each of the front, rear, left and right faces of the chassis unit 310.

The sensor 304 is an ultrasonic sensor, a radar or the like. The sensor 304 emits an ultrasonic wave, an electromagnetic wave or the like in the direction of detection and detects the presence, location, relative velocity or the like of an obstacle in the direction of detection based on the reflected wave. The obstacle may be a pedestrian, a bicycle, a structure or a building, for example. A plurality of sensors 304 may be provided. For example, a sensor 304 directed to the outside of the vehicle may be provided on each of the front, rear, left and right faces of the chassis unit 310.

The motor part 305 includes a driving motor and a steering motor. The driving motor drives each wheel according to a command from the control part 301. The steering motor controls the steering angle of a steering wheel according to a command from the control part 301.

The encoder part 306 includes a driving wheel encoder that detects the rotational speed of a driving wheel and a steering angle encoder that detects the steering angle of the steering wheel. The driving wheel encoder detects the speed of the driving wheel at predetermined time intervals and transmits the speed to the control part 301. The steering angle encoder detects the steering angle at predetermined time intervals and transmits the steering angle to the control part 301.

The GPS receiver 307 receives signals from a plurality of satellites (global positioning satellites) orbiting around the earth and transmits the signal or positional information obtained by processing the signals to the control part 301.

Next, a process performed by each element (the center server 100, the vehicle assembly server 200 and the chassis unit 310) in the vehicle system according to this embodiment and data transmitted and received between the elements will be described.

FIG. 9 is a flow diagram illustrating a process in which the center server 100 updates the vehicle database based on information transmitted from the chassis unit 310 and the vehicle assembly server 200.

The chassis unit 310 can be provided for assembly at a vehicle assembly base. The assembly of a vehicle can be triggered by a dispatch request from a user.

When a vehicle 300 is assembled, the vehicle assembly server 200 (management part 2031) generates information that indicates the presence of the relevant chassis unit 310 and body unit 320 and notifies the center server 100 of the presence (Step S11).

For example, if there is a body unit separated from a chassis unit 310, the vehicle assembly server 200 transmits, to the center server 100, information that the body unit is placed at the vehicle assembly base where the vehicle assembly server 200 is installed. If there is a body unit newly loaded on a chassis unit 310, the vehicle assembly server 200 transmits, to the center server 100, information that the body unit has been loaded on a particular chassis unit 310. Alternatively, the vehicle assembly server 200 may transmit, to the center server 100, information that the assembled chassis unit 310 has left the base and is in operation. When the chassis unit 310 has completed the operation and enters the standby state, the vehicle assembly server 200 transmits, to the center server 100, information that the chassis unit is placed at the vehicle assembly base where the vehicle assembly server 200 is installed.

The chassis unit 310 periodically transmits the location of the vehicle (positional information or information concerning the body unit(s) loaded thereon) to the center server 100 during operation (Step S12).

The center server 100 (vehicle management part 1031) updates the vehicle database based on the received information (Step S13).

The vehicle management part 1031 updates information on a particular chassis unit, such as whether the chassis unit is in operation, the positional information on the chassis unit if the chassis unit is in operation, at which vehicle assembly base the chassis unit is placed if the chassis unit is not in operation, or to which body unit the chassis unit is coupled, as illustrated in FIG. 6(A), for example. Furthermore, the vehicle management part 1031 updates information on a particular body unit, such as whether the body unit is in operation, at which vehicle assembly base the body unit is placed if the body unit is not in operation, or to which chassis unit the body unit is coupled, as illustrated in FIG. 6(B), for example.

When the vehicle 300 is in operation, the center server 100 can obtain the positional information on the chassis unit 310 from the chassis unit 310. Then, if the center server 100 is notified by the vehicle assembly server 200 of information that a certain body unit 320 is coupled to the chassis unit 310, the center server 100 can treat the positional information on the chassis unit 310 as the positional information on the body unit 320.

When the vehicle 300 is not in operation, the positional information on the chassis unit and the body unit can be obtained from the vehicle assembly server 200 that has assembled or disassembled the vehicle.

By the process described above, the center server 100 can grasp the locations of the chassis unit and body unit managed by the center server 100.

Next, a process in which the center server 100 indicates assembly of a vehicle 300 will be described with reference to FIG. 10.

First, the vehicle determination part 1032 obtains a dispatch request for a vehicle 300 (Step S21). The dispatch request for a vehicle 300 may be obtained from a terminal associated with the user or obtained via an input/output device provided in the center server 100. The request may include information concerning the application of the vehicle (such as sales of food and drink, restaurant, or room-temperature freight transportation), information indicating the destination of the dispatch (such as positional information), or information on the service period of the vehicle, for example, in addition to the identifier of the user.

Based on the obtained dispatch request, the vehicle determination part 1032 then determines the combination of body units 320 to be loaded on the chassis unit 310 (Step S22). The combination of body units 320 can be determined based on the assembly data (FIG. 5) stored in the memory part 102, for example.

The vehicle determination part 1032 then determines the vehicle assembly base that can provide the body units 320 to be used (Step S23). The vehicle assembly base that can provide the body units can be determined based on the body information (FIG. 6(B)) stored in the vehicle database. In the example illustrated in the drawing, the body unit with an ID of B003 is on standby at the base A.

The vehicle determination part 1032 then determines the chassis unit 310 to be sent to the user (Step S24). The chassis unit 310 to be sent may be kept at the determined vehicle assembly base. However, if there is no chassis unit kept at the vehicle assembly base, a chassis unit that is located nearby and is not in operation may be selected.

The assembly command part 1033 generates a command (vehicle assembly command) to assemble the determined chassis unit 310 and body unit 320. (Step S25).

The vehicle assembly command is data that specifies the vehicle assembly base where the vehicle 300 is assembled, the relevant chassis unit 310 and the one or more body units 320 to be loaded on the chassis unit, for example. The vehicle assembly command is transmitted to the relevant vehicle assembly server 200 (Step S26).

The vehicle assembly command may include the identifier of the user who has requested for the vehicle, data concerning the service period of the vehicle, or data used for user authentication, for example.

When the relevant chassis unit 310 is located outside the vehicle assembly base, the generated vehicle assembly command may be transmitted to the chassis unit 310 to call the chassis unit 310 to the vehicle assembly base (Step S27A). The chassis unit 310 having received the vehicle assembly command moves to the specified vehicle assembly base (Step S27B).

In Step S28, the vehicle is assembled at the vehicle assembly base.

When the assembly of the vehicle is completed, the vehicle 300 is regarded as being lent to the user and starts the operation. When a predetermined rental period expires, the vehicle 300 may return to the vehicle assembly base. The vehicle assembly server 200 may perform a task of disassembling the body unit(s) 320 from the returned vehicle 300. If this task is performed, the processing in Step S11 is performed, and the vehicle database in the center server 100 is updated.

As described above, according to this embodiment, when assembly of a vehicle used for a predetermined application is requested, the center server 100 selects appropriate body unit(s) 320 to be loaded on the chassis unit 310. In this way, the vehicle desired by the user can be flexibly and quickly provided.

### Second Embodiment

In the first embodiment, the dispatch request includes information concerning the application of the vehicle, and the center server 100 determines the body unit(s) to be combined based on the information.

However, when the application of the vehicle is freight transportation, the number and types of the body units to be loaded may vary with the quantity and type of the freight to be transported. For example, in the example illustrated in FIG. 3E, when the amount of freight is small, the number of transportation units can be reduced so that another unit can be loaded. In the example illustrated in FIG. 3F, the number and types of the body units to be loaded can vary depending on the number of the packages that need to be refrigerated during transportation and the number of the packages that can be transported at room temperature. Furthermore, if there is no package that needs to be refrigerated during transportation, the power supply unit and the cooling unit are unnecessary.

In a second embodiment, to cope with such situations as described above, the dispatch request includes information (type data) concerning the type of the package to be transported and information (quantity data) concerning the quantity of the package. The information concerning the type of the package is “room temperature”, “refrigeration” or “freezing”, for example. However, any other information is possible as far as the information is data that can be used to determine the type of the body unit. The information concerning the quantity of the package is the size, number or weight of each package, for example. However, any other information is possible as far as the information is data that can be used to determine the number of the body units.

In the second embodiment, in Step S22, the vehicle determination part 1032 also determines the combination of the body units 320 to be loaded on the chassis unit 310 based on these pieces of information included in the dispatch request. Specifically, based on the type data/quantity data included in the dispatch request and the amount of the packages that can be stored in one body unit, the vehicle determination part 1032 calculates the number of body units required for the package transportation. Furthermore, the calculation is performed for each package type. The information concerning the amount of the packages that can be stored in one body unit (such as the inner dimensions of a transportation unit) may be stored in advance. A table, a formula or the like used to determine the number of body units based on the quantity data may also be stored in advance.

By this process, the number and types of the body units to be used for the package transportation, such as “three room-temperature transportation units” or “two heat-insulated transportation units”, can be determined. Furthermore, based on the assembly data, a unit other than the transportation unit that is required to provide the service is selected. For example, when performing the refrigerated transportation, the cooling unit and the power supply unit are selected in addition to the heat-insulated transportation unit. Note that the numbers of cooling units and power supply units can be changed according to the number of units (the required capacity).

As described above, according to the second embodiment, an appropriate number of body units can be selected depending on the quantity and types of packages.

(Modifications)

The embodiments described above are just examples, and various modifications are possible without departing from the spirit of the present disclosure.

For example, the processings and units described in the present disclosure can be used in any combination as far as no technical contradiction occurs.

Although the number and types of the body units to be loaded is determined based only on the dispatch request in the embodiments described above, if the space in which the body units are loaded permits, any body unit that is irrelevant to the dispatch request can be loaded to make good use of the space.

Although the vehicle 300 has been illustrated in the embodiments described above, any conveyance other than the vehicle can be assembled.

For example, by loading a body unit with a particular capability on an aircraft platform or a ship platform, an aircraft or ship used for a predetermined application can be assembled.

Furthermore, a processing described as being performed by one device may be performed in cooperation of a plurality of devices. Alternatively, processings described as being performed by different devices may be performed by one device. In the computer system, the hardware component (server component) that provides each function can be flexibly changed.

The present disclosure can also be implemented by installing a computer program that implements the functions described above with regard to the embodiments in a computer and by one or more processors of the computer reading and executing the program. Such a computer program may be provided to the computer via a non-temporary computer readable memory medium that can be connected to a system bus of the computer, or may be provided to the computer via a network. The non-temporary computer readable memory medium may be any type of disk such as a magnetic disk (such as a floppy (registered trademark) disk or a hard disk drive (HDD)) or an optical disk (such as a CD-ROM, a DVD disk or a Blu-ray disk), a read only memory (ROM), a random access memory (RAM), an EPROM, an EEPROM, a magnetic card, a flash memory, an optical card, or any type of medium suitable for storage of an electronic instruction.

What is claimed is:

1. An information processing apparatus comprising a controller configured to
determine a combination of two or more units having different functions to be loaded on a vehicle platform, and
generate a command to assemble a vehicle used for a predetermined application from the determined units.

2. The information processing apparatus according to claim 1, further comprising
a storage unit configured to store the combination of two or more units in association with the application of the vehicle.

3. The information processing apparatus according to claim 2, wherein
the controller obtains information that specifies the application of the vehicle from a user and determines the combination of units suitable for the application based on the stored data.

4. The information processing apparatus according to claim 3, wherein
the application of the vehicle is transportation of freight, and
the two or more units include at least a housing unit that independently functions as a parcel locker.

5. The information processing apparatus according to claim 4, wherein
the two or more units include at least a constant-temperature transportation unit.

6. The information processing apparatus according to claim 4, wherein
the information that specifies the application of the vehicle includes information that indicates a quantity of freight to be transported, and
the controller determines a number of units to be combined based on the quantity of freight.

7. The information processing apparatus according to claim 3, wherein
the application of the vehicle is provision of food and drink, and
the two or more units include at least any of a cooking unit and a water supply and drain unit.

8. The information processing apparatus according to claim 1, wherein
the controller transmits the generated command to a base capable of providing the determined two or more units among a plurality of bases where a vehicle is assembled.

9. The information processing apparatus according to claim 8, wherein
the controller periodically collects, from the plurality of bases, information concerning a unit that is capable of being provided by each base.

10. A vehicle that comprises the vehicle platform and the two or more units specified by the information processing apparatus according to claim 1 that are loaded on the vehicle platform and serves a predetermined function determined by the combination.

11. An information processing method comprising:
a step of determining a combination of two or more units having different functions to be loaded on a vehicle platform; and
a step of generating a command to assemble a vehicle used for a predetermined application from the determined units.

12. The information processing method according to claim 11, further comprising
a step of obtaining data that associates the combination of two or more units with the application of the vehicle.

13. The information processing method according to claim 12, wherein
information that specifies the application of the vehicle is obtained from a user, and the combination of units suitable for the application is determined based on the obtained data.

14. The information processing method according to claim 13, wherein
the application of the vehicle is transportation of freight, and
the two or more units include at least a housing unit that independently functions as a parcel locker.

15. The information processing method according to claim 14, wherein
the two or more units include at least a constant-temperature transportation unit.

16. The information processing method according to claim 14, wherein
the information that specifies the application of the vehicle includes information that indicates a quantity of freight to be transported, and
a number of units to be combined is determined based on the quantity of freight.

17. The information processing method according to claim 13, wherein the application of the vehicle is provision of food and drink, and
the two or more units include at least any of a cooking unit and a water supply and drain unit.

18. The information processing method according to claim 11, further comprising:
a step of transmitting the generated command to a base capable of providing the determined two or more units among a plurality of bases where a vehicle is assembled.

19. The information processing method according to claim 18, further comprising:
a step of periodically collecting, from the plurality of bases, information concerning a unit that is capable of being provided by each base.

20. A non-transitory computer readable storing medium recording a computer program for causing a computer to perform an information processing method comprising:
a step of determining a combination of two or more units having different functions to be loaded on a vehicle platform; and
a step of generating a command to assemble a vehicle used for a predetermined application from the determined units.
